(19) United States
(12) Patent Application Publication
(10) Pub. No.: US 2017/0067702 A1
(43) Pub. Date: Mar. 9, 2017

(54) HEAT TRANSFER DEVICE AND METHOD OF MAKING HEAT TRANSFER DEVICE

(71) Applicants: SHINKO ELECTRIC INDUSTRIES CO., LTD., Nagano (JP); SHINSHU UNIVERSITY, Nagano (JP)

(72) Inventors: Yoriyuki SUWA, Nagano (JP); Kenji KAWAMURA, Nagano (JP); Susumu ARAI, Nagano (JP)

(21) Appl. No.: 15/252,510

(22) Filed: Aug. 31, 2016

(30) Foreign Application Priority Data
Sep. 7, 2015 (JP) 2015-175671

(51) Int. Cl. F28F 21/02; B23P 15/26

(52) U.S. Cl. CPC F28F 21/02; B23P 15/26

(57) ABSTRACT

A heat transfer device includes a base material and a composite plating layer formed on the base material, wherein the composite plating layer includes metal and graphene particles dispersed in the metal.

### CROSS-REFERENCE TO RELATED APPLICATIONS

The present application is based upon and claims the benefit of priority from the prior Japanese Patent Application No. 2015-175671 filed on Sep. 7, 2015, with the Japanese Patent Office, the entire contents of which are incorporated herein by reference.

### FIELD

The disclosures herein relate to a heat transfer device and a method of making a heat transfer device.

### BACKGROUND

A semiconductor device used in a CPU (central processing unit) or the like produces heat during the operation. Dissipating the produced heat away is vital for the performance of the semiconductor device.

A heat transfer device such as a heat spreader or heat pipe may be attached to a semiconductor device, thereby securing a path through which the heat produced by the semiconductor device is dissipated away. Study has been undertaken to improve the heat dissipating capacity (i.e., heat radiating capacity) of a heat transfer device such as a heat spreader and a heat pipe. There has been an attempt to improve the heat dissipating capacity (i.e., heat radiating capacity) of a heat transfer device by forming a metal layer containing carbon ingredients such as carbon nanotubes dispersed therein on the surface of a heat transfer device such as a heat spreader and a heat pipe (see Patent Document 1).

The problem is that dispersed carbon nanotubes are easy to fall off from the metal layer due to their fiber-like shape. Those carbon nanotubes falling off from the metal layer may cause a short circuit between terminals of a semiconductor device to which the heat transfer device is attached, or between lines on a circuit board on which the semiconductor device is mounted.
[Patent Document 1] Japanese Laid-open Patent Publication No. 2010-215977

### SUMMARY

According to an aspect of the embodiment, a heat transfer device includes a base material and a composite plating layer formed on the base material, wherein the composite plating layer includes metal and graphene particles dispersed in the metal.

According to an aspect of the embodiment, a method of making a heat transfer device includes forming a composite plating layer having graphene particles dispersed in metal on a base material, wherein the composite plating layer is formed by use of electroless plating utilizing plating solution that has graphene particles dispersed therein.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a partial cross-sectional view of an example of a heat transfer device according to an embodiment;

FIGS. 2A through 2D are photographs of each sample before and after ultrasonic processing;

FIGS. 3A through 3D are SEM images (magnification of 1000×) of the surface of each sample before and after ultrasonic processing;

FIGS. 4A through 4D are SEM images (magnification of 5000×) of the surface of each sample before and after ultrasonic processing;

FIGS. 5A through 5D are SEM images of the surfaces of graphene particles and graphene-oxide particles; and

FIGS. 6A through 6F are SEM images of the surface of Ni—P/Graphene-oxide taken before and after ultrasonic processing.

### DESCRIPTION OF EMBODIMENTS

In the following, embodiments will be described by referring to the accompanying drawings. In these drawings, the same elements are referred to by the same references, and a duplicate description thereof may be omitted.

### [Structure of Heat Transfer Device]

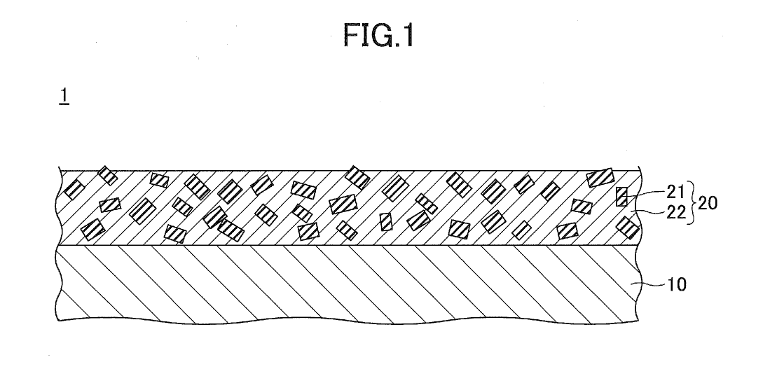

In the following, a description will be given of the structure of a heat transfer device according to a present embodiment. FIG. 1 is a partial cross-sectional view of an example of a heat transfer device according to the present embodiment. A heat transfer device 1 illustrated in FIG. 1 includes a base material 10 and a composite plating layer 20.

The heat transfer device 1 may be applicable to a heat spreader, a vapor chamber, a heat pipe, an LED (light emitting diode) case, and the like. The base material 10 of the heat transfer device 1 is attached to a heat generator such as a semiconductor device. Heat generated by the semiconductor device is rapidly transmitted through the base material 10 to the surface of the composite plating layer 20, and is dissipated away from the surface of the composite plating layer 20.

The base material 10 of the heat transfer device 1 serves as a base on which the composite plating layer 20 is laminated. The base material 10 is preferably made of metal having satisfactory thermal conductivity. Specifically, the base material 10 may be made of copper (Cu), aluminum (Al), or an alloy thereof. It may be noted that the base material 10 may alternatively be resin, silicon, or the like.

The composite plating layer 20 has graphene particles 21 dispersed at high density in metal 22 that is disposed on the base material 10. The thickness of the composite plating layer 20 may approximately be 5 to 20 micrometers, for example. Each of the graphene particles 21, which is single-crystal material, has dimensions of few microns by few microns, and has substantially a submicron thickness. Although the graphene particles 21 may typically be multilayer graphene, single-layer graphene may alternatively be used. The use of single-layer graphene is expected to improve the dispersion characteristics in the metal 22.

The graphene particles 21 are oriented in random directions relative to the surface of the base material 10. Some of the graphene particles 21 have a portion thereof exposed or projecting from the surface of the metal 22. The metal 22 may preferably have satisfactory thermal conductivity and resistance to rusting. Specifically, nickel-phosphorus alloy (hereinafter referred to as Ni—P), which is an alloy of nickel (Ni) and phosphorus (P), may be used.

### [Method of Producing Heat Transfer Device]

In the following, a description will be given of a method of producing the heat transfer device according to the present embodiment. The base material 10 is prepared first. The base material 10 is preferably made of metal having satisfactory thermal conductivity. Specifically, the base material 10 may be made of copper (Cu), aluminum (Al), or an alloy thereof. It may be noted that the base material 10 may alternatively be resin, silicon, or the like.

Electroless plating is then applied to the surface of the base material 10 by use of plating solution having the graphene particles 21 dispersed therein. This process forms the composite plating layer 20 having the graphene particles 21 dispersed in the metal 22. The thickness of the composite plating layer 20 may approximately be 5 to 20 micrometers, for example. It is preferable to grind graphene (e.g. a graphene sheet) by physical force into small particles before dispersion into the plating solution from the viewpoint of improving dispersibility into the plating solution. In order to grind graphene by physical force, a wet-type pulverization machine or an ultrasonic homogenizer may be used. The use of a wet-type pulverization machine enables the grinding of graphene into minute particles, and is thus preferable from the viewpoint of improving the dispersibility of the graphene particles 21 into plating solution.

The electroless plating solution used in the present embodiment may be Ni—P plating solution, for example. In the following, a description will be given of an example case in which Ni—P plating solution is used as an electroless plating solution.

An Ni—P plating solution preferably includes trimethyl stearyl ammonium salt, which is a cationic surface activating agent. The amount of trimethyl stearyl ammonium salt as an additive is responsive to the concentration of the graphene particles 21 in the plating bath. In the case of the concentration of the graphene particles 21 being approximately 10 g/L, the added amount of trimethyl stearyl ammonium salt may preferably be approximately 1 to 10 g/L. Trimethyl stearyl ammonium chloride (TMSAC) may be used as trimethyl stearyl ammonium salt, for example.

The inclusion of trimethyl stearyl ammonium salt in the Ni—P plating solution suppresses the formation of graphene aggregate, thereby serving to satisfactorily disperse the graphene particles 21 in the Ni—P plating solution serving as an electroless plating solution. Trimethyl stearyl ammonium salt, which is a cationic surface activating agent, is charged positively in the Ni—P plating solution, and is closely entangled with the graphene particles 21 to charge the graphene particles 21 positively. While the positively charged graphene particles 21 are strongly attracted to an Ni—P plating coating, the Ni—P plating coating gradually builds up, resulting in the graphene particles 21 being properly embedded in the Ni—P plating coating.

When the Ni—P plating coating builds up, one end of each of the positively charged graphene particles 21 adheres to the Ni—P plating coating. Because of this, many of the graphene particles 21 are embedded in the Ni—P plating coating in a slanted position. Further, some of the graphene particles 21 have a portion thereof exposed or projecting from the surface of the Ni—P plating coating.

In the present embodiment described above, the composite plating layer 20 formed on the base material 10 has the graphene particles 21 dispersed in the metal 22 at high concentration (high density) and having a portion thereof exposed or projecting from the surface of the metal 22. With this arrangement, heat conducted by the base material 10 is transmitted through a large number of graphene particles 21 to reach the graphene particles exposed or projecting from the surface of the metal 22, and dissipated away from the graphene particles 21 exposed or projecting from the surface of the metal 22. The composite plating layer 20 thus exhibits satisfactory heat radiating capacity.

The present embodiment is directed to an example in which the composite plating layer is formed by use of electroless plating. This is because the use of electroless plating enables the formation of a composite plating layer having a thickness that is more even than in the case of electrolytic plating being used. This point is particularly advantageous when the composite plating layer is formed on an object having a complex shape.

Further, the use of electroless plating enables the formation of a composite plating layer with respect to a nonconductive specimen. Even when the base material 10 is not metal but resin or silicon, for example, electroless plating enables the formation of a composite plating layer on the base material 10. However, there may be cases in which electrolytic plating satisfies the specification required for the evenness of layer thickness, and/or in which a composite plating layer needs to be formed on a conductive specimen. In such cases, electrolytic plating may be utilized to form the composite plating layer.

### First Embodiment: Analysis of Radiating Capacity and Falling off of Graphene

The heat transfer device 1 was produced by use of the production process according to the present embodiment. Specifically, a plate of oxygen-free copper (C1020 as defined in the Japan

Industrial Standard) of 31 mm in length, 31 mm in width, and 2 mm in thickness was used. The composite plating layer 20 with a film thickness of 2.5 micrometers having the graphene particles 21 dispersed therein was formed on the plate by use of Ni—P plating solution as an electroless plating solution. Undecorated graphene powder made by Graphene Platform Corporation was used as the graphene particles 21. The composition of the plating bath was as defined in TABLE 1, and the conditions of plating were as defined in TABLE 2. This sample will hereinafter be referred to as “Ni—P/Graphene”.

TABLE 1

| REAGENT | CONCENTRATION |
|---|---|
| Nickel Sulfate Hexahydrate | 0.1M |
| Sodium hypophosphite | 0.2M |
| monohydrate | |
| Trisodium Citrate | 0.2M |
| Ammonium Nitrate | 0.5M |
| Graphene | 10 g/L |
| TMSAC | 4 g/L |

TABLE 2

| ITEM | CONDITION |
|---|---|
| pH | 9 |
| Temperature | 40 Degrees Celsius |
| Time Length of Plating | 60 min |
| Method Of Stirring | BY STIRRER |
| Speed Of Stirring | 450 rpm |

As a comparative sample, an NI—P-alloy plating layer with a film thickness of 2.5 micrometers having no carbon ingredients dispersed therein was formed on the base material 10 having the same specifications as described above to produce a heat transfer device. The composition of the plating bath was as defined in TABLE 3, and the conditions of plating were as defined in TABLE 2.

This sample will hereinafter be referred to as “Ni—P(Ref)”.

TABLE 3

| REAGENT | CONCENTRATION |
|---|---|
| Nickel Sulfate Hexahydrate | 0.1M |
| Sodium hypophosphite | 0.2M |
| monohydrate | |
| Trisodium Citrate | 0.2M |
| Ammonium Nitrate | 0.5M |

As a further comparative sample, a composite plating layer with a film thickness of 2.5 micrometers having carbon nanotubes (CNT) dispersed therein was formed by use of Ni—P plating solution as an electroless plating solution on the base material 10 having the same specifications as described above to produce a heat transfer device. VGCF (registered trademark) was used as the carbon nanotubes. The composition of the plating bath was as defined in TABLE 4, and the conditions of plating were as defined in TABLE 2. This sample will hereinafter be referred to as “Ni—P/CNT”.

TABLE 4

| REAGENT | CONCENTRATION |
|---|---|
| Nickel Sulfate Hexahydrate | 0.1M |
| Sodium hypophosphite | 0.2M |
| monohydrate | |
| Trisodium Citrate | 0.2M |
| Ammonium Nitrate | 0.5M |
| VGCF | 3.2 g/L |
| TMSAC | 6 g/L |

### <<Analysis of Heat Radiating Capacity>>

Ni—P(Ref), Ni—P/CNT, and Ni—P/Graphene produced according to the first embodiment, two samples for each, were compared in terms of heat radiating capacity.

Heat radiating capacity was measured by use of natural convection in room temperature (25.5 degrees Celsius) with respect to the samples that were sequentially attached to a metal block to which a heater and a thermometer were attached. A voltage of 25 V was applied to the heater, resulting in an electric current of 0.195 A, with the electric power being 4. 88 W. The time length of measurement was 60 minutes, with a temperature measurement being taken at one-second intervals. TABLE 5 lists the maximum temperatures in the 60-minute time period.

TABLE 5

| SAMPLE | Ni—P(Ref) | Ni—P/CNT | Ni—P/Graphene |
|---|---|---|---|
| HIGHEST | 116.5 | 109.4 | 112.9 |
| TEMPERATURE | | | |
| (Degrees Celsius) | | | |

As shown in TABLE 5, both Ni—P/Graphene and Ni—P/CNT exhibited better heat radiating capacity than did Ni—P(Ref). Further, Ni—P/Graphene and Ni—P/CNT exhibited heat radiating capacities comparable to each other.

### <<Analysis of Falling-Off>>

A heat transfer device for use in a semiconductor package or the like is embedded in an electronic device such as portable equipment, and is thus subjected to various fluctuations during use. Falling-off of carbon nanotubes and graphene particles from the composite plating layer of a heat transfer device in a large amount may cause a short circuit of the circuitry on a mother board or the like. A device having falling-off in a large amount is thus not suitable as a heat transfer device. The extent to which falling-off occurs was thus compared.

Specifically, Ni—P/Graphene and Ni—P/CNT were subjected to ultrasonic processing, and SEM (scanning electron microscopy) images of the surface of the composite plating layer were taken before and after the ultrasonic processing. With such a procedure, the falling off of graphene particles or carbon nanotubes from the surface of the composite plating layer were visually inspected. An ultrasonic cleaner (Model SC-10A manufactured by SUNCORPORATION) was used for the ultrasonic processing. The conditions used for the processing were 100 W at 28 KHz and a 3-minute length.

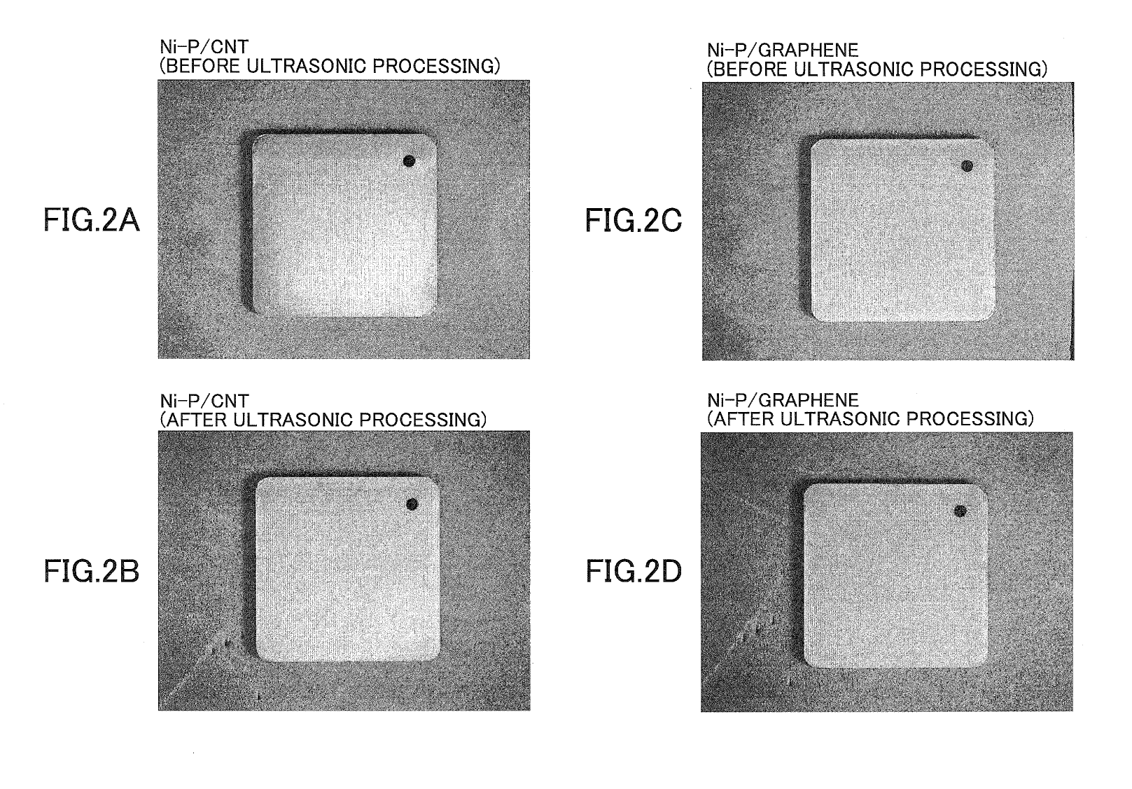

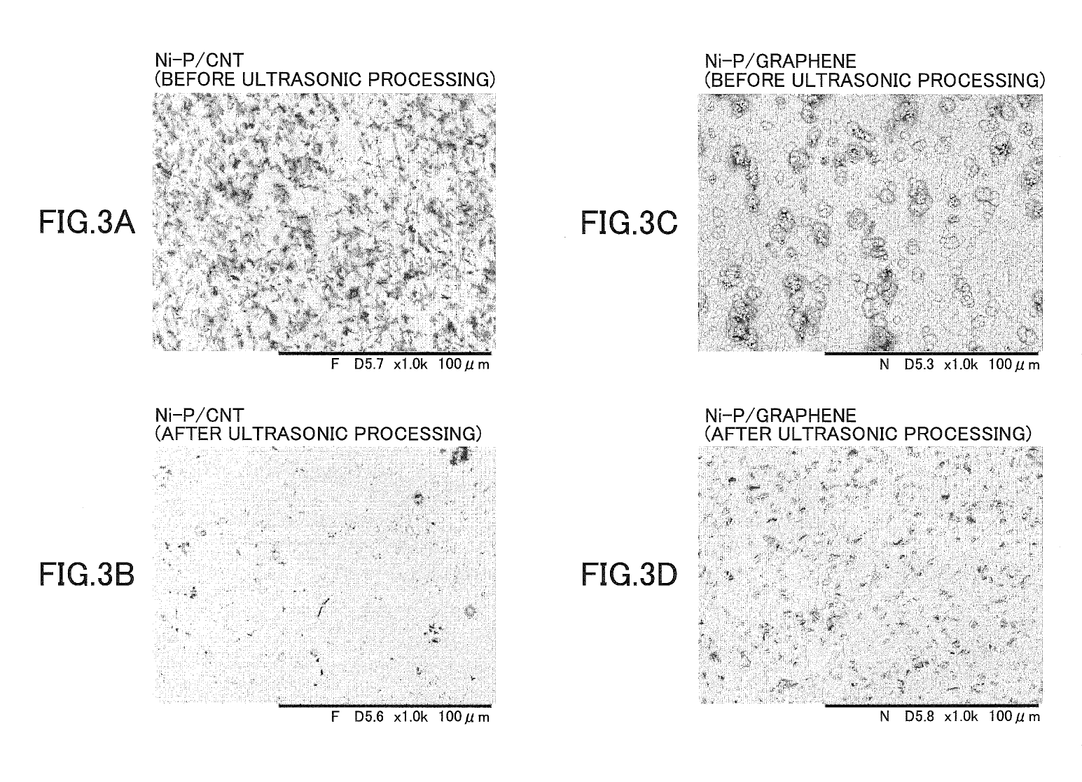

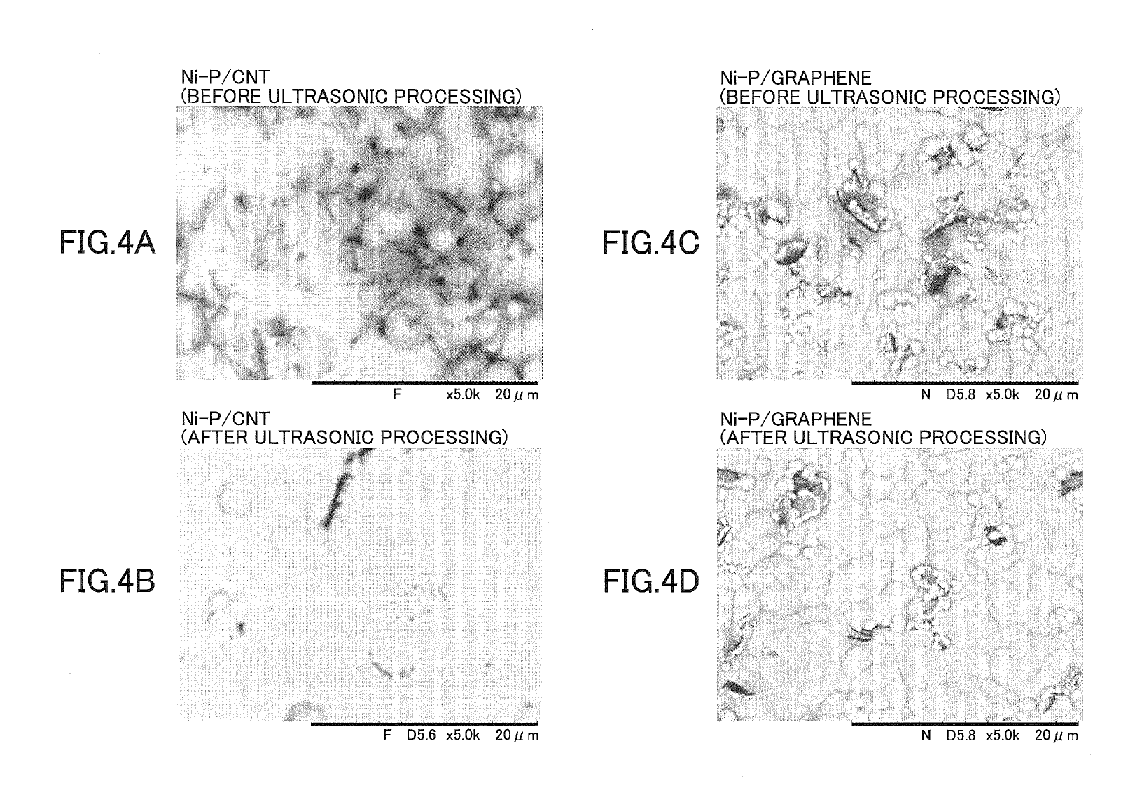

FIGS. 2A through 2D are photographs of each sample before and after the ultrasonic processing. FIGS. 3A through 3D are SEM images (magnification of 1000×) of the surface of each sample before and after the ultrasonic processing. FIGS. 4A through 4D are SEM images (magnification of 5000×) of the surface of each sample before and after the ultrasonic processing.

The conditions of the surfaces before and after the ultrasonic processing were visually inspected by use of the SEM images illustrated in FIGS. 3A through 3D and FIGS. 4A through 4D. The visual inspection revealed that, in the case of Ni—P/CNT, the ultrasonic processing caused almost all the carbon nanotubes to fall off from the surface of the composite plating layer. In the case of Ni—P/Graphene, on the other hand, the visual inspection revealed that almost half the graphene particles still remained on the surface of the composite plating layer after the ultrasonic processing. It can thus be concluded that graphene particles are less likely to fall off from the surface of the composite plating layer than carbon nanotubes.

### <<Conclusion>>

The analysis of heat radiating capacity and the analysis of falling off as described above indicate that NI—P/Graphene and Ni—P/CNT exhibit similar heat radiating capacities, and that the falling off of graphene particles from the composite plating layer of Ni—P/Graphene is significantly fewer than the falling off of carbon nanotubes from the composite plating layer of Ni—P/CNT.

As was previously described, falling-off of carbon ingredients from the composite plating layer in a large amount may cause a short circuit of the circuitry on a mother board or the like. In consideration of this, Ni—P/Graphene, which has less falling off from the composite plating layer, is suitable for use in a heat transfer device from the viewpoint of practical use.

### Second Embodiment: Analysis of Radiating Capacity and Falling off of Graphene Oxide

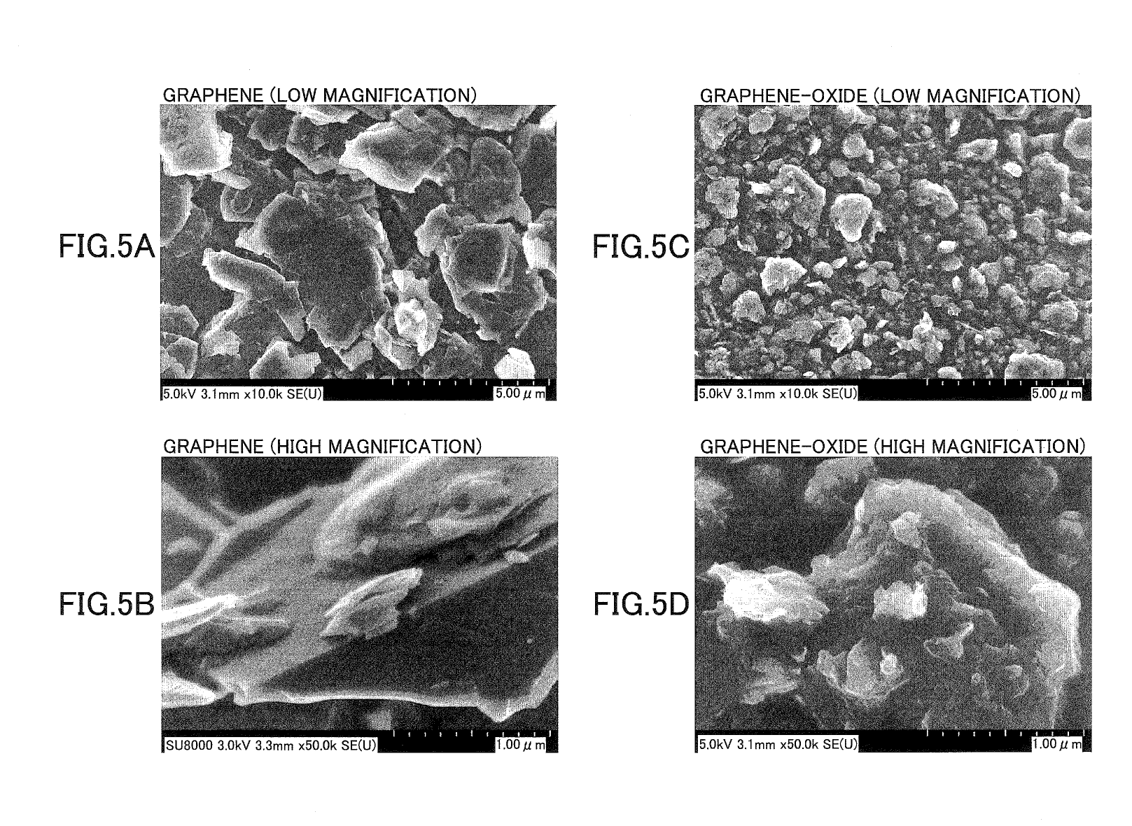

SEM images of the surfaces of graphene particles and graphene-oxide particles were obtained as illustrated in FIGS. 5A through 5D before a heat transfer device was made. FIG. 5A shows an SEM image of graphene particles at a magnification of 1000×. FIG. 5B shows an SEM image of graphene particles at a magnification of 5000×. FIG. 5C shows an SEM image of graphene-oxide particles at a magnification of 1000×. FIG. 5D shows an SEM image of graphene-oxide particles at a magnification of 5000×. As can be seen from FIGS. 5A through 5D, graphene-oxide particles have smaller particle sizes than graphene particles.

The heat transfer device 1 was produced by use of the production process according to the present embodiment. Specifically, a plate of oxygen-free copper (C1020 as defined in the Japan Industrial Standard) of 33 mm in length, 30 mm in width, and 2 mm in thickness was used. The composite plating layer 20 with a film thickness of 2.5 micrometers having the graphene particles 21 dispersed therein was formed on the plate by use of Ni—P plating solution as an electroless plating solution. Undecorated graphene powder made by Graphene Platform Corporation was used as the graphene particles 21. This sample will hereinafter be referred to as “Ni—P/Graphene”.

Further, graphene-oxide particles were used in place of the graphene particles 21 to produce a heat transfer device under the same conditions as described above. This sample will hereinafter be referred to as “Ni—P/Graphene-oxide”. For both of these samples, the composition of the plating bath was as defined in TABLE 6, and the conditions of plating were as defined in TABLE 7.

TABLE 6

| REAGENT | CONCENTRATION |
|---|---|
| Nickel Sulfate Hexahydrate | 0.1M |
| Sodium hypophosphite | 0.2M |
| monohydrate | |
| Trisodium Citrate | 0.2M |
| Ammonium Nitrate | 0.5M |
| Graphene or Graphene-oxide | 4 g/L |
| TMSAC | 4 g/L |

TABLE 7

| ITEM | CONDITION |
|---|---|
| pH | 9 |
| Temperature | 40 Degrees Celsius |
| Time Length of Plating | 120 min |
| Method Of Stirring | BY STIRRER |
| Speed Of Stirring | 450 rpm |

As a comparative sample, an NI—P-alloy plating layer with a film thickness of 2.5 micrometers having no carbon ingredients dispersed therein was formed on the base material 10 having the same specifications as described above to produce a heat transfer device. The composition of the plating bath was as defined in TABLE 3, and the conditions of plating were as defined in TABLE 2 (i.e., the same conditions as in the first embodiment). This sample will hereinafter be referred to as “Ni—P(Ref)”.

### <<Analysis of Heat Radiating Capacity>>

Ni—P(Ref), Ni—P/Graphene, and Ni—P/Graphene-oxide produced according to the second embodiment, two samples for each, were compared in terms of heat radiating capacity. The method of measuring heat radiating capacity was the same as in the first embodiment. TABLE 8 lists the maximum temperatures and so on in the 60-minute time period.

TABLE 8

| | | | Ni—P/Graphene- |
|---|---|---|---|
| SAMPLE | Ni—P(Ref) | Ni—P/Graphene | oxide |
| HIGHEST | 116.8 | 112 | 112.8 |
| TEMPERATURE | | | |
| (Degrees Celsius) | | | |
| v.s. Ni—P(Ref) | — | −4.8 | −4.0 |

As shown in TABLE 8, both Ni—P/Graphene and Ni—P/Graphene-oxide exhibited better heat radiating capacity than did Ni—P(Ref). Further, Ni—P/Graphene and Ni—P/Graphene-oxide exhibited heat radiating capacities comparable to each other.

### <<Analysis of Falling-Off>>

Falling-off of Ni—P/Graphene-oxide was analyzed. Specifically, Ni—P/Graphene-oxide produced according to the second embodiment was subjected to ultrasonic processing, and SEM images of the surface of the composite plating layer were taken before and after the ultrasonic processing. With such a procedure, the falling off of graphene-oxide particles from the surface of the composite plating layer were visually inspected. Further, heat radiating capacity of the Ni—P/Graphene-oxide was compared between before and after the ultrasonic processing. The conditions of the ultrasonic processing and the method of measuring heat radiating capacity were the same as or similar to those of the first embodiment.

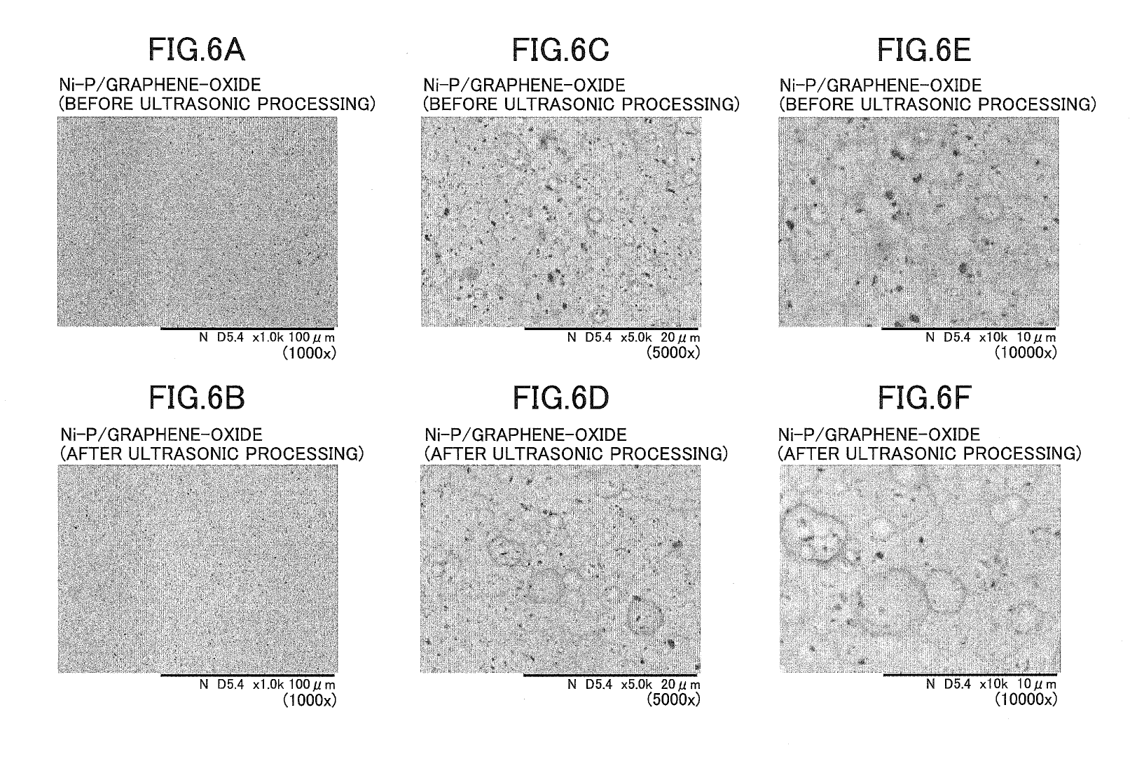

FIGS. 6A through 6F are SEM images of the surface of Ni—P/Graphene-oxide taken before and after the ultrasonic processing. FIG. 6A shows a SEM image (magnification of 1000×) before the ultrasonic processing. FIG. 6B shows a SEM image (magnification of 1000×) after the ultrasonic processing. FIG. 6C shows a SEM image (magnification of 5000×) before the ultrasonic processing. FIG. 6D shows a SEM image (magnification of 5000×) after the ultrasonic processing. FIG. 6E shows a SEM image (magnification of 10000×) before the ultrasonic processing. FIG. 6F shows a SEM image (magnification of 10000×) after the ultrasonic processing.

TABLE 9 shows a change in the heat radiating capacity of Ni—P/Graphene-oxide between before and after the ultrasonic processing.

TABLE 9

Ni—P/Graphene-oxide

| | | Before | After |
|---|---|---|---|
| | | Ultrasonic | Ultrasonic |
| SAMPLE | Ni—P(Ref) | Processing | Processing |
| HIGHEST | 111.9 | 106.6 | 107.4 |
| TEMPERATURE | | | |
| (Degrees Celsius) | | | |
| v.s. Ni—P(Ref) | — | −5.3 | −4.5 |

The surface conditions before and after the ultrasonic processing were visually inspected by use of the SEM images illustrated in FIGS. 6A through 6F. Such visual inspection revealed that almost no graphene-oxide particles fell off during the ultrasonic processing, and most graphene-oxide particles remained on the surface of the composite plating layer. The fact that the heat radiating capacity of Ni—P/Graphene-oxide exhibited almost no change between before and after the ultrasonic processing as shown in TABLE 9 also supports the conclusion that the falling-off of graphene-oxide particles occurred with low probability.

### <<Conclusion>>

The analysis of heat radiating capacity and the analysis of falling-off as described above indicate that Ni—P/Graphene and Ni—P/Graphene-oxide exhibit similar heat radiating capacities, and that the falling off of graphene-oxide particles from the composite plating layer of Ni—P/Graphene-oxide is even fewer than the falling off of graphene particles from the composite plating layer of Ni—P/Graphene.

As was previously described, falling-off of carbon ingredients from the composite plating layer in a large amount may cause a short circuit of the circuitry on a mother board or the like. In consideration of this, Ni—P/Graphene, which has less falling off of carbon ingredients from the composite plating layer than does Ni—P/CNT, is suitable for use in a heat transfer device. Further, Ni—P/Graphene-oxide, which has even less falling off of carbon ingredients from the composite plating layer than does Ni—P/Graphene, is extremely effective.

Graphene-oxide contains a hydrophilic group such as a carboxy group in a large amount, and thus has higher dispersibility in a plating bath than does graphene. Because of this, the use of graphene-oxide can form a plating coating in which graphene-oxide is dispersed more evenly than in the case of graphene. In other words, graphene-oxide is more preferable from the viewpoint that a plating film having homogeneous heat radiating capacity can be formed for a heat transfer device.

At least one embodiment prevents the falling off of carbon ingredients from a heat transfer device having a composite plating layer in which carbon ingredients are dispersed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A heat transfer device, comprising:
a base material; and
a composite plating layer formed on the base material,
wherein the composite plating layer includes metal, and graphene particles dispersed in the metal.

2. The heat transfer device as claimed in claim 1, wherein some of the graphene particles have a portion thereof exposed or projecting from the surface of the metal.

3. The heat transfer device as claimed in claim 1, wherein the metal is a nickel-phosphorus alloy.

4. The heat transfer device as claimed in claim 1, wherein the graphene particles are graphene-oxide particles.

5. A method of making a heat transfer device, comprising forming a composite plating layer having graphene particles dispersed in metal on a base material,
wherein the composite plating layer is formed by use of electroless plating utilizing plating solution that has graphene particles dispersed therein.

6. The method as claimed in claim 5, wherein the metal is a nickel-phosphorus alloy, and the plating solution is an electroless nickel-phosphorus plating solution.

7. The method as claimed in claim 5, wherein the plating solution contains trimethyl stearyl ammonium salt.

8. The method as claimed in claim 7, wherein the trimethyl stearyl ammonium salt is trimethyl stearyl ammonium chloride.

9. The method as claimed in claim 5, further comprising grinding graphene by physical force into particles before dispersion into the plating solution.

10. The method as claimed in claim 5, wherein the graphene particles are graphene-oxide particles.
